(19) United States
(12) Patent Application Publication
(10) Pub. No.: US 2009/0082557 A1
(43) Pub. Date: Mar. 26, 2009

(54) CELLULOSE ACYLATE FILM AND ITS APPLICATIONS

(75) Inventors: Tomoko KUWABARA, Kanagawa (JP); Kunihiro ATSUMI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/234,264

(22) Filed: Sep. 19, 2008

(30) Foreign Application Priority Data
Sep. 21, 2007 (JP) 2007-244787
Mar. 3, 2008 (JP) 2008-051628

(51) Int. Cl. C08B 3/06

(52) U.S. Cl. 536/69

(57) ABSTRACT

A novel cellulose acylate film is disclosed. The film is formed of a composition comprising at least one cellulose acylate having an aromatic group-containing acyl group (Substituent A), in which a substitution degree with Substituent A satisfies following relational expressions (I) and (II):

−0.25≦SA2+DSA3−DSA6≦0.20, (I)

0.35≦DSA2+DSA3+DSA6, (II)
wherein DSA2, DSA3 and DSA6 each indicate a substitution degree with Substituent A at the 2-, 3- and 6-positions of the cellulose acylate.

### CROSS-REFERENCE TO RELATED APPLICATIONS

This application claims benefit of priority under 35 U.S.C. 119 to Japanese Patent Application Nos. 2007-244787 filed on Sep. 21, 2007 and 2008-051628 filed on Mar. 3, 2008; and the entire contents of the applications are incorporated herein by reference.

### BACKGROUND OF THE INVENTION

1. Field of the Invention

The present invention relates to a cellulose acylate film, retardation film, optical compensation film and polarizing plate which are useful as elements to be used in image-displaying devices, and an image-displaying devices employing any of them.

2. Related Art

As liquid crystal display devices have become more popular, the demand of the market on their displaying qualities and their durability have been more and more increased; and further improvement in terms of response speed and viewing angle properties, such as improvement of contrast and color-balance in oblique directions, has been required. For responding such demands, there has been provided various liquid-crystal modes; and research and development of retardation films, which can optically compensate birefringence of liquid-crystal layers employing such liquid-crystal modes respectively, are needed.

For example, as one means for improving viewing-angle properties in the black state of an IPS-mode liquid crystal display device where an electric field parallel to the substrates is applied to the liquid crystal, there has been provided an optical compensation film having in-plane retardation (Re) falling within the range from 190 to 390 nm, and Nz value, which is defined as Rth/Re+0.5, falling within the range from 0.3 to 0.65 (see JPA No. hei 11-305217). Such a film, having large Re and small Rth, which is about 0 nm, may be prepared as follows. A polymer film is attached to a heat-shrinkable film, subjected to stretching treatment under heat, and then separated from the heat-shrinkable film (see JPA Nos. 2000-231016 and hei 5-157911). However, the method may need a large amount of heat-shrinkable films and suffers from complication.

Cellulose acylate films have been widely utilized as polarizer protective films for liquid-crystal display devices, as having transparency and toughness. For example, proposed are optical films of fatty acid acyl cellulose esters such as cellulose acetate propionate, cellulose acetate butyrate, etc. (see JPA No. 2000-352620). Also proposed are optical films of aromatic acyl-substituted cellulose such as cellulose acetate benzoate (see JPA No. 2006-328298). However, the optical performance of these films is limited, and they can not achieve optical properties to be needed for optical compensation of liquid crystal display device employing an IPS-mode or the like, or in other words, large Re and small Rth (Rth is about 0 nm).

### SUMMARY OF THE INVENTION

One object of the present invention is to provide a novel cellulose acylate film having a large absolute value of Re and a small absolute value of Rth, and a retardation film, an optical compensation film, an antireflection film, a polarizing plate and a liquid-crystal display device employing the cellulose acylate film.

The above mentioned objects can be achieved by the means shown below.
[1] A cellulose acylate film formed of a composition comprising at least one cellulose acylate having an aromatic group-containing acyl group (Substituent A), in which a substitution degree with Substituent A satisfies following relational expressions (I) and (II):

−0.25≦DSA2+DSA3−DSA6≦0.20, (I)

0.35≦DSA2+DSA3+DSA6, (II)

wherein DSA2, DSA3 and DSA6 each indicate a substitution degree with Substituent A at the 2-, 3- and 6-positions of the cellulose acylate.
[2] The cellulose acylate film as set forth in [1], wherein the cellulose acylate satisfies following relational expression (III):

2.5<DS≦3.0 (III)

wherein DS indicates a total substitution degree of the cellulose acylate.
[3] The cellulose acylate film as set forth in [1] or [2], wherein the cellulose acylate further has an aliphatic acyl group (Substituent B).
[4] The cellulose acylate film as set forth in [3], wherein the substitution degree, DSB, with Substituent B satisfies following relational expression (IV):

1.70≦DSB≦2.89. (IV)
[5] The cellulose acylate film as set forth in [3] or [4], wherein. Substituent B is a C₂₋₄ aliphatic acyl group.
[6] The cellulose acylate film as set forth in [5], wherein Substituent B is an acetyl group.
[7] The cellulose acylate film as set forth in any one of {1} to [6], wherein Substituent A is selected from the group consisting of a benzoyl group, a phenyl benzoyl group, a 4-heptyl benzoyl group, a 2,4,5-trimethoxy benzoyl group and a 3,4,5-trimethoxy benzoyl group.
[8] The cellulose acylate film as set forth in [7], wherein Substituent A is a benzoyl group, and the substitution degree with Substituent A satisfies following relational expression:

−0.2≦DSA2+DSA3−DSA6≦0.20.
[9] The cellulose acylate film as set forth in any one of [1] to [8], which is a stretched film.
[10] The cellulose acylate film as set forth in any one of [1] to [9], which is a retardation film.
[11] An optical compensation film consisting of or comprising a cellulose acylate film as set forth in any one of [1] to [9].
[12] An antireflection film comprising a cellulose acylate film as set forth in any one of [1] to [9], and an antireflection layer.
[13] A polarizing plate comprising a polarizing film and a cellulose acylate film as set forth in any one of [1] to [9].

### PREFERRED EMBODIMENT OF THE INVENTION

The invention is described in detail hereinunder.

In this description, the numerical range expressed by the wording “a number to another number” means the range that falls between the former number indicating the lowermost limit of the range and the latter number indicating the uppermost limit thereof.

### 1. Cellulose Acylate Composition

The cellulose acylate film of the invention is formed of a composition comprising at least one cellulose acylate having at least an aromatic group-containing acyl group (Substituent A) Cellulose has free hydroxyl groups at the 2-, 3- and 6-positions per the β-1,4-bonding glucose unit thereof. The substitution degree with Substituent A at the 2-, 3-and 6-positions of cellulose is referred to as DSA2, DSA3 and DSA6, respectively, and a cellulose acylate satisfying following relational expressions (I) and (II) is used in the invention.

−0.25≦DSA2+DSA3−DSA6≦0.20, (I)

0.35≦DSA2+DSA3+DSA6. (II)

The present inventors have assiduously studied and, as a result, have found that the presence of an aromatic group-containing acyl group (Substituent A) in a cellulose acylate and the substitution degree with Substituent A at the 2-, 3- and 6-positions remarkably influence the values of Re and Rth of the film formed of the cellulose acylate. More specifically, regarding Rth of the film, they have found that Substituent A at 2- or 3-potion might act to enhance Rth negatively, and that Substituent A at 6-potion might act to enhance Rth positively. On the other hand, regarding Re of the film, they have found that any Substituent A at any of 2-, 3-, and 6-potions might act to increase the absolute value of Re during being stretched. On the basis of this findings, the inventors have further studied and, as a result, have found that, by using a cellulose acylate satisfying the above-mentioned relational expressions (I) and (II), Re and Rth of the film formed of it might be increased and decreased respectively; and a cellulose acylate film having Nz value of 0.5 around, which is defined as Rth/Re+0.5 and has often been used for specifying the optical properties of optical films, can be obtained.

In terms of Nz value coming closer to 0.5, the value of (DSA2+DSA3−DSA6) of benzoyl, which is one examples of Substituent A, is preferably from −0.2 to 0.2, and more preferably from −0.15 to 0.2. In terms of the same, the value of (DSA2+DSA3+DSA6) is preferably equal to or more than 0.37, and more preferably equal to or more than 0.50. The maximum value of (DSA2+DSA3+DSA6) is 3, and the maximum value is obtained when all of the 2-, 3- and 6-positions are substituted with Substituent A. In terms of film's strength and planarity, the cellulose acylate preferably has Substituent B, described in detail later, other than Substituent A; and, in terms of the same, the value of DSA2+DSA3+DSA6 is preferably equal to or smaller than 1.2, and more preferably equal to or smaller than 1.1.

So far as they satisfy above relational expressions (I) and (II), DSA2, DSA3 and DSA6 are not specifically defined in point of their range. Preferably, however, the sum of the substitution degree at the 2- and 3-positions with Substitution A, DSA2+DSA3, is preferably from 0.1 to 1.0, and more preferably from 0.1 to 0.6. On the other hand, the substitution degree at the 6-position with Substitution A, DSA6 is preferably from 0.1 to 1.1 and more preferably from 0.2 to 1.0, in terms of Rth coming closer to 0.

The cellulose acylate may have plural types of aromatic group-containing acyl groups, and regarding any embodiments having plural types thereof, the above-mentioned substitution degree is in terms of the total with the plural groups. For easy production, the cellulose acylate preferably has one type of an aromatic group-containing acyl group.

The total substitution degree with the acyl groups in the cellulose acylate, DS (this includes not only the substitution degree with Substitution A, but also the substitution degree with Substituent B to be mentioned hereinunder) has an influence on the humidity dependence of Rth. In terms of reducing the humidity dependence of Rth, the total substitution degree, DS, of the free hydroxyl group with an acyl group is preferably larger (in this point, the maximum value of the total substitution degree is 3). Concretely, the total substitution degree, DS preferably satisfies following relational expression (III).

2.5≦DS≦3.0 (III)

The total substitution degree, DS, is more preferably from 2.5 to 2.95, and more preferably from 2.5 to 2.9.

In the invention, the substitution degree and the distribution of the substitution degree may be determined according to the method described in Cellulose Communication 6, 73-79 (1999), and Chirality 12(9), 670-674, through ¹H-NMR or ¹³C-NMR.

### 1.-1 Aromatic Group-Containing Acyl Group (Substituent A)

The aromatic group-containing acyl group (substituent A) in the invention may directly bond to the ester-bonding moiety in cellulose, or may bond to it via a linking group. Preferably, it directly bonds to it. The linking group as referred to herein means an alkylene group, an alkenylene group or an alkynylene group, and the linking group may have at least one substituent. The linking group is preferably a C₁₋₁₀ alkylene group, a C₂₋₁₀ alkenylene group or a C₂₋₁₀ alkynylene group, more preferably a C₁₋₆ alkylene group or a C₂₋₆ alkenylene group, even more preferably a C₁₋₄ alkylene group or a C₂₋₄ alkenylene group.

The aromatic group may have at least one substituent. Examples of the substituent of the aromatic group or the above mentioned linking group include alkyls (preferably C₁₋₂₀, more preferably C₁₋₁₂ and even more preferably C₁₋₈ alkyls such as methyl, ethyl, propyl, isopropyl, tert-butyl, n-butyl, n-octyl, n-decyl, n-hexadecyl, cyclopropyl, cyclopentyl, and cyclohexyl), alkenyls (preferably C₂₋₂₀, more preferably C₂₋₁₂ and even more preferably C₂₋₈ alkenyls such as vinyl, allyl, 2-butenyl and 3-pentenyl), alkynyls (preferably C₂₋₂₀, more preferably C₂₋₁₂ and even more preferably C₂₋₈ alkynyls such as propargyl and 3-pentynyl), aryls (preferably C₆₋₃₀, more preferably C₆₋₂₀ and even more preferably C₆₋₁₂ aryls such as phenyl, biphenyl and naphthyl), aminos (preferably C₀₋₂₀, more preferably C₀₋₁₀ and even more preferably C₀₋₆ aminos such as methylamino, dimethylamino, diethylamino and dibenzylamino), alkoxys (preferably C₁₋₂₀, more preferably C₁₋₁₂ and even more preferably C₁₋₈ alkoxys such as methoxy, ethoxy and butoxy), aryloxys (preferably C₆₋₂₀, more preferably C₆₋₁₆ and even more preferably C₆₋₁₂ aryloxys such as phenyloxy and 2-naphtyloxy), acyls (preferably C₁₋₂₀, more preferably C₁₋₁₆ and even more preferably C₁₋₁₂ acyls such as acetyl, benzoyl, formyl and pivaloyl), alkoxycarbonyls (preferably C₂₋₂₀, more preferably C₂₋₁₆ and even more preferably C₂₋₁₂ alkoxycarbonyls such as methoxycarbonyl and ethoxycarbonyl), aryloxycarbonyls (preferably C₇₋₂₀, more preferably C₇₋₁₆ and even more preferably C₇₋₁₀ aryloxycarbonyls such as phenyloxycarbonyl), acyloxys (preferably C₂₋₂₀, more preferably C₂₋₁₆ and even more preferably C₂₋₁₀ acyloxys such as acetoxy and benzoyloxy), acylaminos (preferably C₂₋₂₀, more preferably C₂₋₁₆ and even more preferably C₂₁₀ acylaminos such as acetylamino and benzoylamino), alkoxycarbonylaminos (preferably C₂₋₂₀, more preferably C₂₋₁₆ and even more preferably C₂₋₁₂ alkoxycarbonylaminos such as methoxycarbonylamino), aryloxycarbonylaminos (preferably C₇₋₂₀, more preferably C₇₋₁₆ and even more preferably C₇₋₁₂ aryloxycarbonylaminos such as phenyloxycarbonylamino), sulfonylaminos (preferably C₁₋₂₀, more preferably C₁₋₁₆ and even more preferably C₁₋₁₂ sulfonylaminos such as methane sulfonylaminos and benzene sulfonylaminos), sulfamoyls (preferably C₀₋₂₀, more preferably C₀₋₁₆ and even more preferably C₀₋₁₂ sulfamoyls such as sulfamoyl, methyl sulfamoyl, dimethyl sulfamoyl, and phenyl sulfamoyl), carbamoyls (preferably C₁₋₂₀, more preferably C₁₋₁₆ and even more preferably C₁₋₁₂ carbamoyls such as carbamoyl, methyl carbamoyl, diethyl carbamoyl and phenyl carbamoyl), alkylthios (preferably C₁₋₂₀, more preferably C₁₋₁₆ and even more preferably C₁₋₁₂ alkylthios such as methylthio and ethylthio), arylthios (preferably C₆₋₂₀, more preferably C₆₋₁₆ and even more preferably C₆₋₁₂ arylthios such as phenylthio), sulfonyls (preferably C₁₋₂₀, more preferably C₁₋₁₆ and even more preferably C₁₋₁₂ sulfonyls such as mesyl and tosyl), sulfinyls (preferably C₁₋₂₀, more preferably C₁₋₁₆ and even more preferably C₁₋₁₂ sulfinyls such as methane sulfinyl and benzene sulfinyl), ureidos (preferably C₁₋₂₀, more preferably C₁₋₁₆ and even more preferably C₁₋₁₂ ureidos such as ureido, methyl ureido and phenyl ureido), amide phosphates (preferably C₁₋₂₀, more preferably C₁₋₁₆ and even more preferably C₁₋₁₂ amide phosphates such as diethyl amide phosphate and phenyl amide phosphate), hydroxy, mercapto, halogen atoms such as fluorine, chlorine, bromine and iodine atoms; cyano, sulfo, carboxyl, nitro, hydroxamic acid group, sulfino, hydrazino, imino, hetero cyclic groups (preferably C₁₋₃₀ and more preferably C₁₋₁₂ hetero cyclic groups, in which at least one hetero atom selected from the group consisting of nitrogen, oxygen and sulfur atoms is embedded, such as imidazolyl, pyridyl, quinolyl, furyl, piperidyl, morpholino, benzoxazolyl, benzoimidazolyl, and benzothiazolyl), and silyls (preferably C₃₋₄₀, more preferably C₃₋₃₀ and even more preferably C₃₋₂₄ silyls such as trimethyl silyl and triphenyl silyl). Such substituents may also have at least one substituent. They may be substituted with two or more types of substituents which may be same with or different from each other.

“Aromatic” is defined as an aromatic compound in Dictionary of Physics and Chemistry (by Iwanami Publishing), 4th ed., p. 1208; and the term “aromatic group” in the description is used for any aromatic hydrocarbon groups and any aromatic heterocyclic groups. The aromatic group is preferably an aromatic hydrocarbon group.

The aromatic hydrocarbon group preferably has from 6 to 24 carbon atoms, more preferably from 6 to 12 carbon atoms, and even more preferably from 6 to 10 carbon atoms. Specific examples of the aromatic hydrocarbon group include a phenyl group, a naphthyl group, an anthryl group, a biphenyl group, a terphenyl group; and more preferred is a phenyl group. The aromatic hydrocarbon group is especially preferably a phenyl group, a naphthyl group or a biphenyl group. The aromatic heterocyclic group preferably has at least one of an oxygen atom, a nitrogen atom and a sulfur atom. Specific examples of the heterocyclic group include those derived from furan, pyrrole, thiophene, imidazole, pyrazole, pyridine, pyrazine, pyridazine, triazole, triazine, indole, indazole, purine, thiazoline, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzthiazole, benzotriazole, tetrazaindene. The aromatic heterocyclic group is especially preferably a pyridyl group, a triazinyl group or a quinolyl group.

Examples of the aromatic-group containing acyl group, Substituent A, include phenyl acetyl, hydro cinnamoyl, diphenyl acetyl, phenoxy acetyl, benzoyloxy acetyl, O-acetyl mandelyl, 3-methoxyphenyl acetyl, 4-methoxyphenyl acetyl, 2,5-dimethoxyphenyl acetyl, 3,4-dimethoxyphenyl acetyl, 9-fluorenylmethyl acetyl, cinnamoyl, 4-methoxy-cinnnamoyl, benzoyl, o-toluoyl, m-toluoyl, p-toluoyl, m-anisoyl, p-anisoyl, phenyl benzoyl, 4-ethyl benzoyl, 4-propyl benzoyl, 4-t-butyl benzoyl, 4-butyl benzoyl, 4-pentyl benzoyl, 4-hexyl benzoyl, 4-heptyl benzoyl, 4-octyl benzoyl, 4-vinyl benzoyl, 4-ethoxy benzoyl, 4-butoxy benzoyl, 4-hexyloxy benzoyl, 4-heptyloxy benzoyl, 4-pentyloxy benzoyl, 4-octyloxy benzoyl, 4-nonyloxy benzoyl, 4-decyloxy benzoyl, 4-undecyloxy benzoyl, 4-dodecyloxy benzoyl, 4-isopropyloxy benzoyl, 2,3-dimethoxy benzoyl, 2,5-dimethoxy benzoyl, 3,4-dimethoxy benzoyl, 2,6-dimethoxy benzoyl, 2,4-dimethoxy benzoyl, 3,5-dimethoxy benzoyl, 3,4,5-trimethoxy benzoyl, 2,4,5-trimethoxy benzoyl, 1-naphthoyl, 2-naphthoyl, 2-biphenyl carbonyl, 4-biphenyl carbonyl, 4′-ethyl-4-biphenyl carbonyl, 4′-octyloxy-4-biphenylcarbonyl, piperonyloyl, diphenyl acetyl, triphenyl acetyl, phenyl propionyl, hydro-cinnamoyl, α-methyl hydro-cinnamoyl, 2,2-diphenyl propionyl, 3,3-diphenyl, propionyl, 3,3,3-triphenyl propionyl, 2-phenyl butyryl, 3-phenyl butyryl, 4-phenyl butyryl, 5-phenyl valeryl, 3-methyl-2-phenyl valeryl, 6-phenyl hexanoyl, α-methoxy phenyl acetoxy, phenoxy acetyl, 3-phenoxy propionyl, 2-phenoxy propionyl, 11-phenoxy decanoyl, 2-phenoxy butyryl, 2-methoxy acetyl, 3-(2-methoxyphenyl)propionyl, 3-(p-toluyl)propionyl, (4-methylphenoxy)acetyl, 4-isobutyl-α-methylphenyl acetyl, 4-(4-methoxyphenyl)butyryl, (2, 4-di-t-pentyl phenoxy)-acetyl, 4-(2,4-di-t-pentyl phenoxy)-butyryl, (3,4-dimethoxy phenyl)acetyl, 3,4-(methylene dioxy)phenyl acetyl, 3-(3,4-dimethoxy phenyl)propionyl, 4-(3,4-dimethoxy phenyl)butyryl, (2,5-dimethoxy phenyl)acetyl, (3,5-dimethoxy phenyl)acetyl, 3,4,5-trimethoxy phenyl acetyl, 3-(3,4,5-trimethoxy phenyl)-propionyl acetyl, 1-naphthyl acetyl, 2-naphtyl acetyl, α-trimethyl-2-naphthalene-propionyl, (1-naphthoxy)acetyl, (2-naphthoxy)acetyl, 6-methoxy-α-methyl-2-naphthalene acetyl, 9-fluorene acetyl, 1-pyrene acetyl, 1-pyrene butyryl, γ-oxo-pyrene butyryl, styrene acetyl, α-methyl cinnamoyl, α-phenyl cinnamoyl, 2-methyl cinnamoyl, 2-methoxy cinnamoyl, 3-methoxy cinnamoyl, 2,3-dimethoxy cinnamoyl, 2,4-dimethoxy cinnamoyl, 2,5-dimethoxy cinnamoyl, 3,4-dimethoxy cinnamoyl, 3,5-dimethoxy cinnamoyl, 3,4-(methylene dioxy)cinnamoyl, 3,4,5-trimethoxy cinnamoyl, 2,4,5-trimethoxy cinnamoyl, 3-methylidene-2-carbonyl, 4-(2-cyclohexyloxy)benzoyl, 2,3-dimethyl benzoyl, 2,6-dimethyl benzoyl, 2,4-dimethyl benzoyl, 2,5-dimethyl benzoyl, 3-methoxy-4-methyl benzoyl, 3,4-diethoxy benzoyl, α-phenyl-O-toluyl, 2-phenoxy benzoyl, 2-benzoyl benzoyl, 3-benzoyl benzoyl, 4-benzoyl benzoyl, 2-ethoxy-1-naphthoyl, 9-fluorene carbonyl, 1-fluorene carbonyl, 4-fluorene carbonyl, 9-anthracene carbonyl and 1-pyrene carbonyl.

Among these, preferable examples of Substituent A include phenyl acetyl, hydro-cinnamoyl, diphenyl acetyl, phenoxy acetyl, benzyloxy acetyl, O-acetyl mandelyl, 3-methoxy phenyl acetyl, 4-methoxy phenyl acetyl, 2,5-dimethoxy phenyl acetyl, 3,4-dimethoxy phenyl acetyl, 9-fluorenyl methyl acetyl, cinnamoyl, 4-methoxy-cinnamoyl, benzoyl, o-toluoyl, m-toluoyl, p-toluoyl, m-anisoyl, p-anisoyl, phenyl benzoyl, 4-ethyl benzoyl, 4-propyl benzoyl, 4-t-butyl benzoyl, 4-butyl benzoyl, 4-pentyl benzoyl, 4-hexyl benzoyl, 4-heptyl benzoyl, 4-octyl benzoyl, 4-vinyl benzoyl, 4-ethoxy benzoyl, 4-butoxy benzoyl, 4-hexyloxy benzoyl, 4-heptyloxy benzoyl, 4-pentyloxy benzoyl, 4-octyloxy benzoyl, 4-nonyloxy benzoyl, 4-decyloxy benzoyl, 4-undecyloxy benzoyl, 4-dodecyloxy benzoyl, 4-isopropyloxy benzoyl, 2,3-dimethoxy benzoyl, 2,5-dimethoxy benzoyl, 3,4-dimethoxy benzoyl, 2,6-dimethoxy benzoyl, 2,4-dimethoxy benzoyl, 3,5-dimethoxy benzoyl, 2,4,5-trimethoxy benzoyl, 3,4,5-trimethoxy benzoyl, 1-naphthoyl, 2-naphthoyl, 2-biphenyl carbonyl, 4-biphenyl carbonyl, 4′-ethyl-4-biphenyl carbonyl and 4′-octyloxy-4-biphenyl carbonyl.

Among these, more preferable examples of Substituent A include phenyl acetyl, diphenyl acetyl, phenoxy acetyl, cinnamoyl, 4-methoxy-cinnamoyl, benzoyl, phenyl benzoyl, 4-ethyl benzoyl, 4-propyl benzoyl, 4-t-butyl benzoyl, 4-butyl benzoyl, 4-pentyl benzoyl, 4-hexyl benzoyl, 4-heptyl benzoyl, 3,4-dimethoxy benzoyl, 2,6-dimethoxy benzoyl, 2,4-dimethoxy benzoyl, 3,5-dimethoxy benzoyl, 2,4,5-trimethoxy benzoyl, 3,4,5-trimethoxy benzoyl, 1-naphthoyl, 2-naphthoyl, 2-biphenyl carbonyl and 4-biphenyl carbonyl.

Among these, even more preferable examples of Substituent A include benzoyl, phenyl benzoyl, 4-heptyl benzoyl, 2,4,5-trimethoxy benzoyl and 3,4,5-trimethoxy benzoyl.

The cellulose acylate may have one or more different types of Substitution A.

### 1.-2 Aliphatic Acyl Group (Substituent B)

The cellulose acylate may additionally have any other acyl group than the aromatic group-containing acyl group (substituent A), concretely, an aliphatic acyl group (Substituent B).

The aliphatic acyl group (substituent B) in the invention may be any of linear, branched or cyclic-structured aliphatic acyl groups, or may be an unsaturated bond-containing aliphatic acyl group. Preferably, it is an aliphatic acyl group having from 2 to 20 carbon atoms, more preferably from 2 to 10 carbon atoms, even more preferably from 2 to 4 carbon atoms. Preferred examples of Substitution B include an acetyl group, an propionyl group and a butyryl group. Above all, more preferred is an acetyl group. Having an acetyl group as Substitution B, the cellulose acylate may form a film having a suitable glass transition point (Tg) and a suitable modulus of elasticity. When having an aliphatic acyl group having a small number of carbon atoms, such as an acetyl group, the film may have a suitable strength without lowering its Tg and modulus of elasticity.

The substitution degree DSB with Substitution B preferably satisfies following relational expression (IV):

1.70≦DSB≦2.89. (IV)

The substitution degree (DSB) with Substitution B is more preferably from 1.70 to 2.80, even more preferably from 1.75 to 2.80. Within the range, the starting material, diacetyl cellulose is favorable as it may have high solubility and its production may be easy.

Examples of the cellulose acylate which can be used in the invention, include, but are not limited to, those shown in the following table.

| | | DSA2 + | DSA2 + | | |
|---|---|---|---|---|---|
| | | DSA3 + | DSA3 − | | |
| No. | Substituent A | DSA6 | DSA6 | Substituent B | DS |
| A-1 | benzoyl | 0.55 | −0.15 | acetyl | 2.70 |
| A-2 | benzoyl | 0.60 | −0.10 | acetyl | 2.75 |
| A-3 | benzoyl | 0.65 | −0.05 | acetyl | 2.80 |
| A-4 | heptyl benzoyl | 0.55 | −0.15 | acetyl | 2.70 |
| A-5 | heptyl benzoyl | 0.60 | −0.10 | acetyl | 2.75 |
| A-6 | heptyl benzoyl | 0.65 | −0.05 | acetyl | 2.80 |
| A-7 | heptoxy benzoyl | 0.55 | −0.15 | acetyl | 2.70 |
| A-8 | heptoxy benzoyl | 0.60 | −0.10 | acetyl | 2.75 |
| A-9 | heptoxy benzoyl | 0.65 | −0.05 | acetyl | 2.80 |
| A-10 | butyl benzoyl | 0.55 | −0.15 | acetyl | 2.70 |
| A-11 | Butyl benzoyl | 0.60 | −0.10 | acetyl | 2.75 |
| A-12 | Butyl benzoyl | 0.65 | −0.05 | acetyl | 2.80 |
| A-13 | butoxy benzoyl | 0.55 | −0.15 | acetyl | 2.70 |
| A-14 | butoxy benzoyl | 0.60 | −0.10 | acetyl | 2.75 |
| A-15 | butoxy benzoyl | 0.65 | −0.05 | acetyl | 2.80 |
| A-16 | octyl benzoyl | 0.55 | −0.15 | acetyl | 2.70 |
| A-17 | octyl benzoyl | 0.60 | −0.10 | acetyl | 2.75 |
| A-18 | octyl benzoyl | 0.65 | −0.05 | acetyl | 2.80 |
| A-19 | octyloxy benzoyl | 0.55 | −0.15 | acetyl | 2.70 |
| A-20 | octyloxy benzoyl | 0.60 | −0.10 | acetyl | 2.75 |
| A-21 | octyloxy benzoyl | 0.65 | −0.05 | acetyl | 2.80 |
| A-22 | nonyloxy benzoyl | 0.55 | −0.15 | acetyl | 2.70 |
| A-23 | nonyloxy benzoyl | 0.60 | −0.10 | acetyl | 2.75 |
| A-24 | nonyloxy benzoyl | 0.65 | −0.05 | acetyl | 2.80 |
| A-25 | decyloxy benzoyl | 0.55 | −0.15 | acetyl | 2.70 |
| A-26 | decyloxy benzoyl | 0.60 | −0.10 | acetyl | 2.75 |
| A-27 | decyloxy benzoyl | 0.65 | −0.05 | acetyl | 2.80 |
| A-28 | undecyloxy | 0.55 | −0.15 | acetyl | 2.70 |
| | benzoyl | | | | |
| A-29 | undecyloxy | 0.60 | −0.10 | acetyl | 2.75 |
| | benzoyl | | | | |
| A-30 | undecyloxy | 0.65 | −0.05 | acetyl | 2.80 |
| | benzoyl | | | | |
| A-31 | dodecyloxy | 0.55 | −0.15 | acetyl | 2.70 |
| | benzoyl | | | | |
| A-32 | dodecyloxy | 0.60 | −0.10 | acetyl | 2.75 |
| | benzoyl | | | | |
| A-33 | dodecyloxy | 0.65 | −0.05 | acetyl | 2.80 |
| | benzoyl | | | | |
| A-34 | 4-phenyl benzoyl | 0.65 | 0 | acetyl | 2.85 |
| A-35 | 4-phenyl benzoyl | 0.75 | 0.05 | acetyl | 2.90 |
| A-36 | 4-phenyl benzoyl | 0.80 | 0.10 | acetyl | 2.95 |
| A-37 | benzoyl | 0.75 | −0.05 | acetyl | 2.51 |
| A-38 | benzoyl | 0.80 | 0 | acetyl | 2.56 |
| A-39 | Benzoyl | 0.85 | 0.05 | acetyl | 2.61 |
| A-40 | benzoyl | 0.90 | 0.10 | acetyl | 2.66 |
| A-41 | benzoyl | 0.95 | 0.15 | acetyl | 2.71 |
| A-42 | benzoyl | 1.0 | 0.20 | acetyl | 2.76 |
| A-43 | benzoyl | 1.05 | 0.25 | acetyl | 2.81 |

The cellulose acylate is a cellulose skeleton-having compound that is produced by biologically or chemically introducing at least an aromatic group-containing acyl group (substituent A) into a starting material, cellulose.

For the starting material cotton for cellulose acylate, usable is not only natural cellulose such as cotton linter and wood pulp (broad-leaved tree pulp, coniferous tree pulp), but also cellulose having a low degree of polymerization (degree of polymerization of from 100 to 300) that is obtained through acid hydrolysis of wood pulp, such as microcrystalline cellulose; and as the case may be their mixture may also be used. The details of the starting material cellulose are described, for example, in “Plastic Material Lecture (17), Cellulosic Resin” (written by Marusawa, Uda, published by Nikkan Kogyo Shinbun-sha, 1970); Hatsumei Kyokai Disclosure Bulletin 2001-1745 (pp. 7-8); and “Encyclopedia of Cellulose (p. 523)” (edited by the Society of Cellulose of Japan, published by Asakura Shoten, 2000). Cellulose described in these references can be used herein, to which, however, the invention should not be limited.

Cellulose acylate which can be used in the invention may be prepared, for example, by reacting Aldrich's cellulose acylate (having a degree of acetyl substitution of 2.45) or Daicel's cellulose acetate (having a degree of acetyl substitution of 2.41 (tradename, L-70), or2.15 (tradename, FL-70), which is a starting material, with a corresponding acid chloride. In general, starting from a cellulose acetate in which the hydroxyl groups are partly substituted with an acetyl group, it may be reacted with an acid chloride such as benzoyl chloride so as to introduce Substitution A thereinto, and Substitution A may be predominantly introduced into the 6-position. For obtaining a cellulose acylate having Substitution A predominantly introduced into the 2- and 3-positions, cellulose acetate is once deacetylated under a basic condition so as to predominantly remove the 2- and 3-positioned acetyl groups, and thereafter it is acylated with an acid chloride, thereby obtaining a cellulose acylate having Substitution A predominantly introduced into the 2- and 3-positions and having the acetyl group remaining essentially at the 6-position as a substituent B. The deacetylation may be attained, for example, in the presence of amine and water. By controlling the degree of acetyl substitution of the starting material cellulose acetate, the condition in deacetylation and the condition for substituent A introduction, a cellulose acylate satisfying the above formulae (I) and (II) may be produced.

Not specifically defined, the viscosity-average degree of polymerization of the cellulose acylate is preferably from 80 to 700, more preferably from 90 to 500, even more preferably from 100 to 500. When the polymer has a mean degree of polymerization of at most 500, then the viscosity of the cellulose acylate dope may not be too high and the film formation with the dope by casting may be easy. When the polymer has a degree of polymerization of at least 140, it is favorable since the intensity of the film formed of it may increase. The mean degree of polymerization may be measured, for example, according to an Uda et al's limiting viscosity method (Kazuo Uda, Hideo Saito; the Journal of the Society of Fiber Science and Technology of Japan, Vol. 18, No. 1, pp. 105-120, 1962). Concretely, it may be measured according to the method described in JPA No. hei 9-95538.

### 1.-3 Cellulose Acylate Composition

The cellulose acylate composition, which is used for preparing the cellulose acylate film of the invention, will be described below.

The cellulose acylate composition comprises at least one above-mentioned cellulose acylate.

Preferably, the cellulose acylate composition comprises the cellulose acylate in an amount of from 70% by mass to 100% by mass of the whole composition, more preferably from 80% by mass to 100% by mass, even more preferably from 90% by mass to 100% by mass.

The cellulose acylate composition may be in any form of granules, powders, fibers, bulks, solutions or melts.

The starting material for film formation is preferably granular or powdery; and therefore, the cellulose acylate composition after dried may be ground or sieved for unifying the particle size and for improving the handlability thereof.

In the invention, one or more different types of cellulose acylates may be used either singly or as combined. As the case may be, the composition may contain any other polymer component than cellulose acylate and may contain various additives. Preferably, the ingredients to be mixed for the composition are well compatible with cellulose acylate; and preferably, the composition mixed with them may form a film having a transmittance of at least 80%, more preferably at least 90%, even more preferably at least 92%.

In the invention, various additives generally applicable to cellulose acylate (for example, UV inhibitor, plasticizer, antioxidant, fine particles, optical characteristics modulator) may be added to the cellulose acylate to prepare a composition. Regarding the time at which the additives are added to the cellulose acylate, they may be added at any time in the process of dope preparation, or may be added in the final modulation step of the dope preparation process.

### 2. Cellulose Acylate Film

The invention relates to a cellulose acylate film.

The cellulose acylate film of the invention preferably contains the above-mentioned cellulose acylate in an amount of at least 50% by mass, more preferably at least 80% by mass, even more preferably at least 95% by mass.

The production method for the cellulose acylate film of the invention is not specifically defined. Preferably, the film is produced according to a melt casting process or a solution casting process to be described below. More preferred is a solution casting process. Both the melt casting process and the solution casting process may produce the cellulose acylate film of the invention like ordinary processes. For example, for melt casting film formation, referred to is JPA No. 2006-348123; and for solution casting film formation, referred to is JPA No. 2006-241433.

### 2.-1 Solution Casting Film Formation

Preferred embodiments of solution casting film formation for the cellulose acylate film of the invention are described below.

In the solution casting process, a solution of cellulose acylate is first prepared, and then the solution is cast on the surface of a support and formed into a film thereon. The solvent to be used in preparing the cellulose acylate solution is not specifically defined. Preferred solvents are chlorine-containing organic solvents such as dichloromethane, chloroform, 1,2-dichloroethane, tetrachloroethane, and chlorine-free organic solvents. The chlorine-free organic solvents are preferably selected from esters, ketones and ethers having from 3 to 12 carbon atoms. The esters, the ketones and the ethers may have a cyclic structure. Compounds having two or more functional groups of esters, ketones and ethers (i.e., —O—, —CO— and —COO—) are also usable herein as a main solvent; and they may have any other functional group such as an alcoholic hydroxyl group. In case where the main solvent has two or more functional groups, the number of the carbon atoms constituting them may fall within a range of the number of carbon atoms that constitute the compound having any of those functional groups. Examples of the esters having from 3 to 12 carbon atoms are ethyl formate, propyl formate, pentyl formate, methyl acetate, ethyl acetate, pentyl acetate. Examples of the ketones having from 3 to 12 carbon atoms are acetone, methyl ethyl ketone, diethyl ketone, diisobutyl ketone, cyclopentanone, cyclohexanone, methylcyclohexanone. Examples of the ethers having from 3 to 12 carbon atoms are diisopropyl ether, dimethoxymethane, dimethoxyethane, 1,4-dioxane, 1,3-dioxolane, tetrahydrofuran, anisole and phenetole. Examples of the organic solvents having plural functional groups are 2-ethoxyethyl acetate, 2-methoxyethanol, 2-butoxyethanol.

In preparing the cellulose acylate solution, it is desirable that cellulose acylate is dissolved in an organic solvent to a degree of from 10 to 35% by mass, more preferably from 13 to 30% by mass, even more preferably from 15 to 28% by mass. In order to dissolve the cellulose acylate in the organic solvent to prepare a solution having the concentration that falls within the range, for example, employable is a method of dissolving it to have a desired concentration in the dissolution step, or a method of first preparing a low-concentration solution (for example, having a concentration of from 9 to 14% by mass) and then concentrating it into a high-concentration solution in the subsequent concentration step. Apart from these, also employable is a method comprising first preparing a high-concentration cellulose acylate solution and then adding various additives thereto to convert it into a low-concentration cellulose acylate solution having a predetermined low concentration.

The cellulose acylate solution, dope, may be prepared according to any dissolution method such as dissolution at room temperature, under cooling or heat, and any combinations thereof. Such methods are described in JPA Nos. hei 5-163301, syo 61-106628, syo 58-127737, hei 9-95544, hei 10-95854, hei 10-45950, 2000-53784, hei 11-322946, hei 11-322947, hei 2-276830, 2000-273239, hei 11-71463, hei 04-259511, 2000-273184, hei 11-323017 and hei 11-302388; and they can be used in the invention. The details of the treatment are described in Hatsumei Kyokai Disclosure Bulletin (No. 2001-1745, published on Mar. 15, 2001 by the Hatsumei Kyokai), p. 22-25. In the process of preparing the cellulose acylate solution, it may be concentrated or filtered. The details of the treatment are described in Hatsumei Kyokai Disclosure Bulletin (No. 2001-1745, published on Mar. 15, 2001 by the Hatsumei Kyokai), p. 25. When the polymer is dissolved at high temperatures, then the dissolving temperature is not lower than the boiling point of the organic solvent used in most cases, and in those cases, the system may be processed under pressure.

### 2.-2 Example of Method for Producing Cellulose Acylate Film

Regarding the method and the equipment for producing the cellulose acylate film of the invention, any conventional solution casting film formation methods and solution casting film formation devices used for producing conventional cellulose acylate films are usable in the invention. A dope (cellulose acylate solution) prepared in a dissolver (tank) is once stored in a storage tank, in which the dope is degassed to be a final dope. The dope is fed into a pressure die from the dope discharge port of the tank, via a metering pressure gear pump through which a predetermined amount of the dope can be fed with accuracy, for example, based on the controlled revolution thereof, and then the dope is uniformly cast onto the metal support of a casting unit that runs endlessly, via the slit of the pressure die. Then, at a peeling point at which the metal support reaches almost after having traveled round, a semi-dried dope film (this may be referred to as a web) is peeled from the metal support. Clipped at its both ends by clips to keep its cross width as such, the resulting web is dried while being conveyed with a tenter, then transported with rolls in the drying device, and after having thus dried, it is wound up with a winder to a predetermined length. The combination of the tenter and the drying device with rolls may be varied depending on the object of the method. In solution-casting film formation for silver halide photographic materials or functional protective films for electronic displays, additional coating devices may be added to the solution casting film formation device, for surface processing of the films for forming an undercoat layer, an antistatic layer, an antihalation layer and a protective layer thereon. The processing steps are described in detail in Hatsumei Kyokai Disclosure Bulletin (No. 2001-1745, published on Mar. 15, 2001 by the Hatsumei Kyokai), pp. 25-30, as grouped into casting (including co-casting), metal support, drying, peeling, and stretching.

### 2.-3 Treatment of Cellulose Acylate Film

### Stretching:

The cellulose acylate film of the invention, thus produced according to the melt casting process or the solution casting process mentioned above, may be stretched.

During the film formation process, the film may be stretched in an on-line mode, or after the film has been formed, it may be once wound up and then stretched in an off-line mode. Specifically, in the melt casting process, the film formed may be stretched before or after it has been completely cooled.

Preferably, the film is stretched at a temperature falling between Tg and (Tg+50° C.), more preferably between Tg and (Tg+40° C.), even more preferably between Tg and (Tg+30° C.). Also preferably, the stretching ratio for the stretching is from 0.1 to 300%, more preferably from 10 to 200%, even more preferably from 30 to 100%. The stretching may be carried out in one stage or in multiple stages. The stretching ratio may be obtained according to the following formula:

Stretching Ratio (%)=100×{(length after stretching)−(length before stretching)}/(length before stretching).

The stretching may be carried out according to a machine-direction stretching, transverse-direction stretching or their combination. Examples of the machine-direction stretching includes (1) roll stretching (using at least two pairs of nip rolls of which the speed of the roll on the take-out side is kept higher, the film is stretched in the machine direction, such stretching is usually called “free-edge stretching”), (2) fixed-edge stretching (both edges of the film are fixed, and the film is stretched by conveying it in the machine direction gradually at an elevated speed in the machine direction). The transverse-direction stretching may be tenter stretching (both edges of the film are held with a chuck, and the film is expanded and stretched in the transverse direction (in the direction perpendicular to the machine direction)). The machine-direction stretching and the transverse-direction stretching may be carried out either alone (monoaxial stretching) or may be combined (biaxial stretching). In the biaxial stretching, the machine-direction stretching and the transverse-direction stretching may be effected successively (successive stretching) or simultaneously (simultaneous stretching).

Both in the machine-direction stretching and the transverse-direction stretching, the stretching speed is preferably from 10%/min to 10000%/min, more preferably from 20%/min to 1000%/min, even more preferably from 30%/min to 800%/min. In the multi-stage stretching, the stretching speed is the mean value of the stretching speed in each stage.

After thus stretched in the manner as above, it is desirable that the film is relaxed in the machine direction or in the transverse direction by from 0% to 10%. Further, after thus stretched, it is also desirable that the film is thermally fixed at 150° C. to 250° C. for 1 second to 3 minutes.

After thus stretched, the thickness of the film is preferably from 10 to 300 μm, more preferably from 20 μm to 200 μm, even more preferably from 30 μm to 100 μm.

Preferably, the angle θ formed by the film-traveling direction (machine direction) and the slow axis of Re of the film is nearer to 0°, +90° or −90°. Concretely, in machine-direction stretching, the angle is preferably nearer to 0°, more preferably to 0±3°, even more preferably to 0±2°, still more preferably to 0±1°. In transverse-direction stretching, the angle is preferably 90±3° or −90±3°, more preferably 90±2° or −90±2°, even more preferably 90±1° or −90±1°.

In case where the film has Re owing to the tension applied in the machine direction thereto during the process of casting to peeling the film, its Re may be made to be near to 0 (zero) by stretching the film in the transverse direction with a tenter. In this case, the preferred draw ratio is from 0.1 to 20%, more preferably from 0.5 to 10%, even more preferably from 1 to 5%.

The stretching treatment may be effected during the film formation process; or after the unstretched film is once rolled up, it may be stretched. In the former case, the film may be stretched while it still contains the solvent remaining therein, and the film may be favorably stretched when the remaining solvent content is from 2 to 30% by mass.

The thickness of the dried cellulose acetate film may vary, depending on the use and the object of the film; and preferably, it is within a range of from 5 to 500 μm, more preferably within a range of from 20 to 300 μm, even more preferably within a range of from 30 to 150 μm. For optical use, especially for VA liquid-crystal display devices, the film thickness is preferably from 40 to 110 μm. The film thickness may be controlled to be a desired one, by controlling the solid content of the dope, the slit distance of the spinneret of the die, the extrusion pressure through the die and the speed of the metal support.

The cellulose acylate film of the invention may be formed as a long continuous film. For example, it may be formed as a roll of long continuous film having a width of from 0.5 to 3 m (preferably from 0.6 to 2.5 m, more preferably from 0.8 to 2.2 m) and a length per roll of from 100 to 10000 m (preferably from 500 to 7000 m, more preferably from 1000 to 6000 m). In winding up to a roll, the film is preferably knurled at least on one edge thereof, and the knurling width is preferably from 3 mm to 50 mm, more preferably from 5 mm to 30 mm, and the knurling height is preferably from 0.5 to 500 μm, more preferably from 1 to 200 μm. This may be attained by one-side pressing or both-side pressing.

The above-mentioned, unstretched or stretched cellulose acylate film may be used either alone or as combined with a polarizer; and a liquid-crystal layer or a layer having a controlled refractivity (low-refractivity layer) or a hard coat layer may be provided on it for use herein.

### 2.-4 Optical Properties of Cellulose Acylate Film

In the description, Re(λ) and Rth(λ) each indicate the in-plane retardation (unit:nm) and the thickness direction retardation (unit:nm) at a wavelength λ. Re(λ) is measured by applying a light having a wavelength of λ nm in the normal line direction of a sample of a film, using KOBRA-21ADH or WR (by Oji Scientific Instruments).

When the film to be tested is represented by an uniaxial or biaxial refractive index ellipsoid, then its Rth(λ) is calculated according to the method mentioned below.

With the in-plane slow axis (determined by KOBRA 21ADH or WR) taken as the inclination axis (rotation axis) of the sample (in case where the sample has no slow axis, the rotation axis of the sample may be in any in-plane direction of the sample), Re(λ) of the sample is measured at 6 points in all thereof, up to +50° relative to the normal line direction of the sample at intervals of 10°, by applying a light having a wavelength of λ nm from the inclined direction of the sample.

With the in-plane slow axis from the normal line direction taken as the rotation axis thereof, when the sample has a zero retardation value at a certain inclination angle, then the symbol of the retardation value of the sample at an inclination angle larger than that inclination angle is changed to a negative one, and then applied to KOBRA 21ADH or WR for computation.

With the slow axis taken as the inclination axis (rotation axis) (in case where the sample has no slow axis, the rotation axis of the sample may be in any in-plane direction of the film), the retardation values of the sample are measured in any inclined two directions; and based on the data and the mean refractive index and the inputted thickness of the sample, Rth may be calculated according to the following formulae (11) and (12):

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & ( 11 ) \\ Rth = \{ ( nx + ny ) / 2 - nz \} \times d & ( 12 )\end{matrix}$$

wherein Re(θ) means the retardation value of the sample in the direction inclined by an angle θ from the normal line direction; nx means the in-plane refractive index of the sample in the slow axis direction; ny means the in-plane refractive index of the sample in the direction vertical to nx; nz means the refractive index of the sample vertical to nx and ny; and d is a thickness of the sample.

When the sample to be tested can not be represented by a monoaxial or biaxial index ellipsoid, or that is, when the sample does not have an optical axis, then its Rth(λ) may be calculated according to the method mentioned below.

With the in-plane slow axis (determined by KOBRA 21ADH or WR) taken as the inclination axis (rotation axis) of the sample, Re(λ) of the sample is measured at 11 points in all thereof, from −50° to +50° relative to the normal line direction of the sample at intervals of 10°, by applying a light having a wavelength of λ nm from the inclined direction of the sample. Based on the thus-determined retardation data of Re(λ), the mean refractive index and the inputted thickness of the sample, Rth(λ) of the sample is calculated with KOBRA 21ADH or WR.

The mean refractive index may be used values described in catalogs for various types of optical films. When the mean refractive index has not known, it may be measured with Abbe refractometer. The mean refractive index for major optical film is described below: cellulose acetate (1.48), cycloolefin polymer (1.52), polycarbonate (1.59), polymethylmethacrylate (1.49), polystyrene (1.59).

Re and Rth of the cellulose acylate film of the invention may be controlled by controlling the total degree of substitution, the distribution of the degree of substitution at the 2-, 3- and 6-positioned substituents, and the draw ratio in stretching. The cellulose acylate film of the invention contains a cellulose acylate in which the degree of substitution of Substitution A satisfies the above formulae (I) and (II), and therefore has a large absolute value of Re and a small absolute value of Rth. Concretely, the cellulose acylate film of the invention may have Re of from 120 to 400 nm around, Rth of from −40 to 30 nm around and Nz value of 0.5 around (more specifically Nz value of from 0.25 to 0.65); but its Re, Rth and Nz value are not limited to these ranges.

For the cellulose acylate film of the invention, used is a cellulose acylate satisfying the above formulae (I) and (II), and satisfying the above formula (III) in point of the total degree of substitution thereof, and therefore, the film may have above-mentioned optical properties and the humidity dependence of Rth of the film may be small. Concretely, ΔRth of the film, or that is, the difference between Rth of the film at a wavelength of 590 nm at 25° C. and 80% RH and Rth thereof at a wavelength of 590 nm and at 25° C. and 10% RH is from 10 to 25 nm around, and the humidity dependence of Rth of the film is small.

The fluctuation of Re(590) of the film in the transverse direction is preferably ±5 nm, more preferably ±3 nm. The fluctuation of Rth(590) of the film in the transverse direction is preferably ±10 nm, more preferably ±5 nm. Also preferably, the fluctuation of Re and Rth of the film in the machine direction is within the range of the fluctuation thereof in the transverse direction.

One example of the film prepared by stretching the cellulose acylate film of the invention is a film having an in-plane slow axis being perpendicular to the stretching direction. The direction of the in-plane slow axis of the cellulose acylate film subjected to stretching treatment may depend on the values of DS and DSA2+DSA3−DSA6 of the cellulose acylate, which is a material of the film. More specifically, the direction of the in-plane slow axis of the cellulose acylate film subjected to a stretching treatment may be perpendicular to the stretching direction when the film is prepared by using a cellulose acylate having large values of DS and DSA2+DSA3−DSA6 (namely the value of DSA6 is relatively small). Accordingly, the cellulose acylate film of the invention, subjected to a stretching treatment, may have the in-plane slow axis being perpendicular to the stretching direction. However, the invention is not limited to such an embodiment. It is to be noted that a direction of an in-plane slow axis of a film can be found by using KOBRA 21ADH.

### 2.-5 Equilibrium Water Content of Cellulose Acylate Film

The water content of the cellulose acylate film of the invention may be determined as follows: A sample of the film, 7 mm×35 mm is analyzed using a water content meter and a sample drier (Aquacounter AQ-200, LE-20S, both by Hiranuma Sangyo), according to a Curl-Fisher method. The water content (g) is divided by the mass (g) of the sample to obtain the equilibrium water content of the film.

The equilibrium water content of the cellulose acylate film of the invention is preferably from 0 to 10% at 25° C. and 80% RH, more preferably from 0.1 to 7%, even more preferably from 0.3 to 5%. The film having an equilibrium water content of more than 10% is unfavorable because, when the film is used as the support of an optical compensation film, the humidity change dependence of the retardation thereof is great and the optical compensatory capability of the film lowers.

### 2.-6 Haze of Cellulose Acylate Film

Preferably, the haze of the cellulose acylate film, as measured with a haze meter (1001DP Model by Nippon Denshoku), is from 0.1 to 0.8, more preferably from 0.1 to 0.7, even more preferably from 0.1 to 0.6. When the haze of the film is controlled to fall within the range and when the optical compensation film comprising it is incorporated in a liquid-crystal display device, then the device may give high-contrast images.

### 2.-7 Photoelasticity Coefficient of Cellulose Acylate Film

The cellulose acylate film of the invention is preferably used as a protective film for polarizing plate or as a retardation plate. In case where the film is used as a protective film for polarizing plate or as a retardation plate, then its birefringence (Re, Rth) may vary owing to its expansion through moisture absorption or to its stress through shrinkage. The birefringence change through stress of the film may be determined as the photoelasticity coefficient thereof, and its range is preferably from 5×10⁻⁷ (cm²/kgf) to 30×10⁻⁷ (cm²/kgf), more preferably from 6×10⁻⁷ (cm²/kgf) to 25×10⁻⁷ (cm²/kgf), even more preferably from 7×10⁻⁷ (cm²/kgf) to 20×10⁻⁷ (cm²/kgf),

### 2.-8 Glass Transition Temperature

The glass transition temperature of a cellulose acylate film can be measured according to a method as set forth in JIS K7121.

The glass transition temperature of the cellulose acylate film of the invention is preferably from 80° C. to 300° C., and more preferably from 100° C. to 250° C. The glass transition temperature of the film may be reduced by adding at least low molecular-compound such as a plasticizer and solvent to the film.

### 2.-9 Surface Treatment of Cellulose Acylate Film

The unstretched or stretched cellulose acylate film may be optionally subjected to surface treatment to thereby improve the adhesiveness between the cellulose acylate film and various functional layers (e.g., undercoat layer, back layer) adjacent thereto. The surface treatment is, for example, glow discharge treatment, UV irradiation treatment, corona treatment, flame treatment, or acid or alkali treatment.

### 3. Retardation Film

The cellulose acylate film of the invention may be used as a retardation film.

Preferably, the cellulose acylate film of the invention is combined with functional layers described in detail in Hatsumei Kyokai Disclosure Bulletin (No. 2001-1745, published on Mar. 15, 2001 by the Hatsumei Kyokai), pp. 32-45. Above all, it is desirable that the film is provided with a polarizing layer (for polarizer), an optical compensatory layer (for optical compensation film) and an antireflection layer (for antireflection film).

### 4. Optical Compensation Film

The cellulose acylate film of the invention may be used as an optical compensation film of a liquid crystal display. The cellulose acylate film, having optical properties to be required for optical compensation, may be used itself as an optical compensation film. Or, for obtaining optical properties to be required for optical compensation, on the cellulose acylate film, an optically anisotropic layer of a liquid crystal composition or a birefringent polymer layer may be formed, and, then, such lamination may be used as an optical compensation film.

### 5. Antireflection Film

The invention also relates to an antireflection film comprising the cellulose acylate film of the invention and an antireflection layer. The antireflection film may be produced according to ordinary production methods, and for example, it may be produced with reference to JPA No. 2006-241433.

### 6. Polarizing Plate

The invention also relates to a polarizing plate comprising a polarizing film and two protective films sandwiching the polarizing film between them, in which at least one of the two protective films is the cellulose acylate film of the invention. The cellulose acylate film of the invention may be stuck to the polarizing film as a part of the optically-anisotropic layer-having optical compensation film to be stuck thereto or as a part of the antireflection layer-having antireflection film thereto. In case where the polarizing plate has any other layer, it is desirable that the surface of the cellulose acylate film of the invention is stuck to the surface of the polarizing film. For example, the polarizing plate may be fabricated with reference to JPA No. 2006-241433.

6. Image Display device

The invention also relates to an image display device comprising at least one cellulose acylate film of the invention. In the display device, the cellulose acylate film of the invention serves as a retardation film or an optical compensation film, or as a part of a polarizing plate or an antireflection film therein.

### 6.-1 Liquid-Crystal Display Device

The cellulose acylate film of the invention is favorably employed in a liquid-crystal display device as a retardation film or as a part of a polarizing plate, an optical compensation film or an antireflection film comprising a cellulose acylate film therein. Examples of the liquid-crystal display device include TN-mode, IPS-mode, FLC-mode, AFLC-mode, OCB-mode, STN-mode, ECB-mode, VA-mode and HAN-mode display devices; and preferred is an IPS-mode device. The cellulose acylate film of the invention may be favorably used in any of transmission-type, reflection-type or semitransmission-type liquid-crystal display devices.

In case where the cellulose acylate film of the invention is used in IPS-mode liquid-crystal display devices, the film is preferably disposed between the liquid-crystal cell and the displaying-side polarizing plate or the backlight-side polarizing plate therein. The film may function as a protective film for the displaying-side polarizing plate or the backlight-side polarizing plate, and in such a case, the film may be incorporated into a liquid-crystal display device as one member of the polarizing plate therein, and may be disposed between the liquid-crystal cell and the polarizing film in the device. By disposing the cellulose acylate film at the above mentioned position in an IPS-mode liquid crystal display device, it is possible to improve the displaying quality, especially reduce the color shift in the oblique direction in the black state. According to the embodiment employed in an IPS-mode liquid crystal display device, the cellulose acylate film of the invention preferably has Rth of from −40 nm to 30 nm and Re of from 120 nm to 400 nm. And, Nz value of the film is preferably 0.5 around, and more specifically, Nz value is preferably from 0.25 to 0.65. According to the embodiment, preferably, the cellulose acylate film of the invention is disposed so that the in-plane slow axis of the film is parallel or perpendicular to the absorption axis of the displaying-side polarizing film (or the backlight-side polarizing film).

In this embodiment, it is desirable that there exists no other retardation layer than the cellulose acylate film and the positive A plate between the displaying-side polarizing film or the backlight-side polarizing film and the liquid-crystal cell. Accordingly, for example, in case where the displaying-side polarizing plate or the backlight-side polarizing plate has any other polarizing plate protective film than the cellulose acylate film of the positive A plate and the protective film is disposed between the liquid-crystal cell and the displaying-side polarizing film or the backlight-side polarizing film, then the an isotropic polymer film having Re and Rth of both almost 0 (zero) is preferably used for the protective film; and as the polymer film of the type, preferably used is the cellulose acylate film described in JPA No. 2006-030937.

### EXAMPLES

The invention is described more concretely with reference to the following Examples. In the following Examples, the amount and the ratio of the material, the reagent and the substance used, and the operation may be suitably modified or changed not overstepping the sprit and the scope of the invention. Accordingly, the scope of the invention should not be limited to the following Examples.

### 1. Synthetic Examples

### 1.-1 Synthetic Example 1

### Synthesis of Compound A-1 Exemplified above as an Example of Cellulose Acylate

200 g of acetyl cellulose having a degree of substitution of 2.15, 2 L of acetone and 132 mL of pyridine were taken into a 5-L three-neck flask equipped with a mechanical stirrer, a thermometer, a condenser tube and a dropping funnel, and stirred at room temperature. In the flask, 190 mL of benzoyl chloride was gradually and dropwise added to it, and after the addition, this was further stirred at 60° C. for 5 hours. After the reaction, this was left cooled to room temperature, and the reaction solution was poured into 10 L of methanol with vigorously stirring, whereupon a white solid deposited. The white solid was taken out through suction filtration, and washed three times with a large quantity of methanol. The obtained white solid was dried overnight at 60° C., and dried in vacuum at 90° C. for 6 hours to give 230 g of the intended compound, Compound A-1, as a white powder. The mean degree of polymerization was 270.

### 1.-2 Synthetic Example 2

### Synthesis of Compound A-2 Exemplified above as an Examples of Cellulose Acylate

In the same manner as the synthesis of Compound A-1, 250 g of Compound A-2 was prepared as a white powder, except that the amount of pyridine was changed from 132 mL to 146 mL, and the amount of benzoyl chloride was changed from 190 mL to 210 mL. The mean degree of polymerization was 275.

### 1.-3 Synthetic Example 3

### Synthesis of Compound A-3 Exemplified above as an Examples of Cellulose Acylate

In the same manner as the synthesis of Compound A-1, 270 g of Compound A-3 was prepared as a white powder, except that the amount of pyridine was changed from 132 mL to 160 mL, and the amount of benzoyl chloride was changed from 190 mL to 230 mL. The mean degree of polymerization was 272.

### 1.-4 Synthetic Example 4

### Synthesis of Compound A-5 Exemplified above as an Examples of Cellulose Acylate

In the same manner as the synthesis of Compound A-1, 290 g of Compound A-5 was prepared as a white powder, except that the amount of pyridine was changed from 132 mL to 128 mL, and 392 mL of 4-phenyl benzoyl chloride (manufactured by Wako Pure Chemical) was used in place of 190 mL of benzoyl chloride. The mean degree of polymerization was 273.

### 1.-5 Synthetic Example 5

### Synthesis of Compound A-35 Exemplified above as an Examples of Cellulose Acylate

In the same manner as the synthesis of Compound A-1, 270 g of Compound A-35 was prepared as a white powder, except that the amount of pyridine was changed from 132 mL to 146 mL, and 228 g of phenyl benzoyl chloride (manufactured by Wako Pure Chemical) was used in place of 190 mL of benzoyl chloride. The mean degree of polymerization was 275.

### 1.-6 Synthetic Example 6

### Synthesis of Compound A-37 Exemplified above as an Examples of Cellulose Acylate

100 g of acetyl cellulose having a degree of substitution of 1.76 and 1000 mL of pyridine were taken into a 5-L three-neck flask equipped with a mechanical stirrer, a thermometer, a condenser tube and a dropping funnel, and stirred at room temperature. In the flask, 42 mL of benzoyl chloride was gradually and dropwise added to it, and after the addition, this was further stirred at 60° C. for 5 hours. After the reaction, this was left cooled to room temperature, and the reaction solution was poured into 10 L of methanol with vigorously stirring, whereupon a white solid deposited. The white solid was taken out through suction filtration, and washed three times with a large quantity of methanol. The obtained white solid was dried overnight at 60° C., and dried in vacuum at 90° C. for 6 hours to give 105 g of the intended compound, Compound A-37, as a white powder. The mean degree of polymerization was 110.

### 1.-7 Synthetic Example 7

### Synthesis of Compound A-38 Exemplified as an Example of Cellulose Acylate

In the same manner as the synthesis of Compound A-37, 108 g of Compound A-38 was prepared as a white powder, except that the amount of benzoyl chloride was changed from 42 mL to 43 mL. The mean degree of polymerization was 112.

### 1.-8 Synthetic Example 8

### Synthesis of Compound A-39 Exemplified above as an Examples of Cellulose Acylate

In the same manner as the synthesis of Compound A-37, 109 g of Compound A-39 was prepared as a white powder, except that the amount of benzoyl chloride was changed from 42 mL to 44 mL. The mean degree of polymerization was 110.

### 1.-9 Synthetic Example 9

### Synthesis of Compound A-40 Exemplified above as an Example of Cellulose Acylate

In the same manner as the synthesis of Compound A-37, 110 g of Compound A-40 was prepared as a white powder, except that the amount of benzoyl chloride was changed from 42 mL to 45 mL. The mean degree of polymerization was 110.

### 1.-10 Synthetic Example 10

### Synthesis of Compound A-41 Exemplified above as an Example of Cellulose Acylate

In the same manner as the synthesis of Compound A-37, 110 g of Compound A-41 was prepared as a white powder, except that the amount of benzoyl chloride was changed from 42 mL to 46 mL. The mean degree of polymerization was 118.

### 1.-11 Synthetic Example 11

### Synthesis of Compound A-43 Exemplified above as an Example of Cellulose Acylate

In the same manner as the synthesis of Compound A-37, 112 g of Compound A-43 was prepared as a white powder, except that the amount of benzoyl chloride was changed from 42 mL to 47 mL. The mean degree of polymerization was 119.

### 1.-12 Synthetic Example 12

### Synthesis of Comparative Compound B-1

This was produced according to the method described in JPA No. 2006-328298. 100 g of cellulose and 100 mL of water were taken into a 5 L three-neck flask equipped with a mechanical stirrer, and stirred overnight, and water was removed through reduced-pressure filtration. 400 mL of methanol (Wako Pure Chemical) was added to the obtained slurry, and stirred at room temperature for 1 hour, and then filtered under reduced pressure. This operation was repeated twice. 400 mL of dimethylacetamide (Wako Pure Chemical) was added to the obtained slurry, and stirred at room temperature for 1 hour, and then filtered under reduced pressure. This operation was repeated three times, thereby obtaining an activated cellulose. 1000 mL of dimethylacetamide and lithium chloride (Wako Pure Chemical) were taken into a 5 L three-neck flask equipped with a mechanical stirrer, a thermometer, a condenser tube and a dropping funnel, and dissolved at 80° C. After cooled to 40° C., the activated cellulose was added to it, and stirred for 1 hour. This was cooled to room temperature, and 93 g of acetic acid (Wako Pure Chemical), 38 g of benzoic acid (Wako Pure Chemical), 380 g of dicyclohexylcarbodiimide (Wako Pure Chemical), 130 g of 4-dimethylaminopyridine (Wako Pure Chemical), and 130 g of dimethylaminopyridinium p-toluenesulfonate (Tokyo Kasei) were added to it, and stirred for 24 hours. After the reaction, this was left cooled to room temperature, and the reaction solution was poured into 5 L of water with vigorously stirring, whereby a white solid deposited. The white solid was taken out through suction filtration, and washed three times with a large quantity of methanol. The obtained white solid was dried overnight at 60° C., and then dried in vacuum at 90° C. for 6 hours to give 90 g of the intended comparative compound B-1, as a white powder. The mean degree of polymerization of the compound was 250.

### 1.-13 Synthetic Example 13

### Synthesis of Comparative Compound B-2

130 g of a comparative compound B-2, was produced in the same manner as in production of Cellulose acylate B-1, for which, however, the amount of acetic acid was changed from 93 g to 89 g, the amount of benzoic acid was changed from 38 g to 226 g, and the amount of dicyclohexylcarbodiimide (Wako Pure Chemical) was changed from 380 g of 420 g. The mean degree of polymerization was 250.

### 1.-14 Synthetic Example 14

### Synthesis of Intermediate Compound C-1

200 g of acetyl cellulose having a degree of substitution of 2.93, 4000 mL of dimethylsulfoxide and 80 mL of water were taken into a 5-L three-neck flask equipped with a mechanical stirrer, a thermometer, a condenser tube and a dropping funnel, and stirred at 60° C. for 20 hours. After the reaction, this was left cooled to room temperature, and the reaction solution was poured into 10 L of methanol with vigorously stirring, whereupon a white solid deposited. The white solid was taken out through suction filtration, and washed three times with a large quantity of methanol. The obtained white solid was dried overnight at 60° C., and dried in vacuum at 90° C. for 6 hours to give 182 g of the intended compound, Intermediate compound C-1, as a white powder.

### 1.-15 Synthetic Example 15

### Synthesis of Comparative Compound B-3

40 g of Intermediate compound C-1 obtained in the previous reaction and 400 mL of pyridine were taken into a 3 L three-neck flask equipped with a mechanical stirrer, a thermometer, a condenser tube and a dropping funnel, and stirred at room temperature for 5 hours. In the flask, 85 mL of benzoyl chloride was gradually and dropwise added to it, and after the addition, this was further stirred at 70° C. for 5 hours. After the reaction, this was left cooled to room temperature, and the reaction solution was poured into 10 L of methanol with vigorously stirring, whereupon a white solid deposited. The white solid was taken out through suction filtration, and washed three times with a large quantity of methanol. The obtained white solid was dried overnight at 60° C., and dried in vacuum at 90° C. for 6 hours to give 45 g of the intended compound, Comparative compound B-3 as a white powder. The mean degree of polymerization was 316.

### 2. EXAMPLES

### 2.-1 Example 1

### Production of Cellulose Acylate Film

Using the cellulose acylate shown in the following Table, cellulose acylate films were produced according to the method mentioned below.

### 2.-1-1 Preparation of Cellulose Acylate Solution 1

The following materials were put into a mixing tank, and stirred under heat and dissolved to prepare a cellulose acylate-containing solution.

| | |
|---|---|
| Cellulose acylate shown in Table below | 100 mas. pts. |
| Methylene chloride (first solvent) | 500 mas. pts. |

### 2.-1-2 Preparation of Cellulose Acylate Solution 2

The following materials were put into a mixing tank, and stirred under heat and dissolved to prepare a cellulose acylate-containing solution.

| | |
|---|---|
| Cellulose acylate shown in Table below | 100 mas. pts. |
| Methylene chloride (first solvent) | 402 mas. pts. |
| Methanol (second solvent) | 60 mas. pts. |

### 2.-1-3 Production of Cellulose Acylate Film Sample

562 parts by mass of the cellulose acylate-containing solution was cast, using a band caster to form a film. The film having a residual solvent content of 15% by mass was subjected to a fixed-edge or free-edge monoaxial stretching with a stretching ratio shown in the table at a temperature of Tg+25° C. to form each of cellulose acylate films shown in the table. Unless otherwise specifically indicated in the following description, the thickness of each film produced was all 80 μm.

### 2.-1-4 Evaluation of Cellulose Acylate Film Sample

Each of the film samples was evaluated as follows: A part (120 mm×120 mm) of each film sample obtained in the above was prepared. Using “KOBRA 21ADH” (by Oji Scientific Instruments), Re and Rth of the sample piece at a wavelength of 590 nm were measured. The results are shown in the following Table.

TABLE 2

| | Cellulose | | | | | | | | Stretching | | |
|---|---|---|---|---|---|---|---|---|---|---|---|
| | Acylate | | | | DSA2 + | | | | | ratio | |
| Film No. | No. | Substitution A | (II) *1 | (I) *2 | DSA3 | DSA6 | DS | Solution *3 | method *4 | (%) | Note *5 |
| SA-1 | A-1 | benzoyl | 0.55 | −0.15 | 0.20 | 0.35 | 2.70 | 1 | fixed | 45 | I |
| SA-2 | A-2 | benzoyl | 0.60 | −0.10 | 0.25 | 0.35 | 2.75 | 1 | — | 0 | I |
| SA-3 | A-2 | benzoyl | 0.60 | −0.10 | 0.25 | 0.35 | 2.75 | 1 | fixed | 30 | I |
| SA-4 | A-2 | benzoyl | 0.60 | −0.10 | 0.25 | 0.35 | 2.75 | 1 | fixed | 45 | I |
| SA-5 | A-2 | benzoyl | 0.60 | −0.10 | 0.25 | 0.35 | 2.75 | 1 | fixed | 60 | I |
| SA-6 | A-2 | benzoyl | 0.60 | −0.10 | 0.25 | 0.35 | 2.75 | 1 | free | 30 | I |
| SA-7 | A-3 | benzoyl | 0.65 | −0.05 | 0.30 | 0.35 | 2.80 | 1 | fixed | 60 | I |
| SA-8 | A-3 | benzoyl | 0.65 | −0.05 | 0.30 | 0.35 | 2.80 | 1 | fixed | 45 | I |
| SA-9 | A-5 | 4-heptyl | 0.60 | −0.10 | 0.25 | 0.35 | 2.75 | 1 | fixed | 60 | I |
| | | benzoyl | | | | | | | | | |
| SA-10 | A-35 | 4-phenyl | 0.75 | 0.05 | 0.40 | 0.35 | 2.9 | 1 | fixed | 30 | I |
| | | benzoyl | | | | | | | | | |
| SA-11 | A-37 | benzoyl | 0.75 | −0.05 | 0.35 | 0.40 | 2.51 | 1 | fixed | 45 | I |
| SA-12 | A-37 | benzoyl | 0.75 | −0.05 | 0.35 | 0.40 | 2.51 | 1 | free | 45 | I |
| SA-13 | A-38 | benzoyl | 0.80 | 0 | 0.40 | 0.40 | 2.56 | 1 | fixed | 60 | I |
| SA-14 | A-38 | benzoyl | 0.80 | 0 | 0.40 | 0.40 | 2.56 | 2 | fixed | 60 | I |
| SA-15 | A-39 | benzoyl | 0.85 | 0.05 | 0.45 | 0.40 | 2.61 | 1 | fixed | 45 | I |
| SA-16 | A-39 | benzoyl | 0.85 | 0.05 | 0.45 | 0.40 | 2.61 | 1 | fixed | 60 | I |
| SA-17 | A-39 | benzoyl | 0.85 | 0.05 | 0.45 | 0.40 | 2.61 | 1 | fixed | 75 | I |
| SA-18 | A-40 | benzoyl | 0.90 | 0.10 | 0.50 | 0.40 | 2.66 | 1 | fixed | 45 | I |
| SA-19 | A-40 | benzoyl | 0.90 | 0.10 | 0.50 | 0.40 | 2.66 | 1 | fixed | 60 | I |
| SA-20 | A-40 | benzoyl | 0.90 | 0.10 | 0.50 | 0.40 | 2.66 | 1 | fixed | 75 | I |
| SA-21 | A-41 | benzoyl | 0.95 | 0.15 | 0.55 | 0.40 | 2.71 | 1 | fixed | 60 | I |
| SA-22 | A-42 | benzoyl | 1.00 | 0.20 | 0.60 | 0.40 | 2.76 | 1 | fixed | 60 | I |
| SB-1 | B-1 | benzoyl | 0.30 | −0.25 | 0.02 | 0.27 | 2.60 | 1 | fixed | 30 | C |
| SB-2 | B-2 | benzoyl | 0.70 | −0.48 | 0.11 | 0.59 | 2.90 | 1 | fixed | 30 | C |
| SB-3 | B-3 | benzoyl | 0.49 | 0.35 | 0.42 | 0.07 | 3.00 | 1 | fixed | 30 | C |

*1: Value “DSA2 + DSA3 + DSA6” of Substitution A in Cellulose Acylate
*2: Value “DSA2 + DSA3 − DSA6” of Substituent A in Cellulose Acylate
*3: “1” indicates using Cellulose Acylate Solution 1, and “2” indicates using Cellulose Acylate 2.
*4: “fixed” indicates carrying out a fixed-edge monoaxial stretching, and “free” indicates carrying out a free-edge monoaxial stretching.
*5: “I” indicates an example of the invention; and “C” indicates a comparative example.

TABLE 3

| Cellulose acylate | Rth | Re*1 | | |
|---|---|---|---|---|
| Film No. | (nm) | (nm) | Nz value | Note |
| SA-1 | 10 | 120 | 0.58 | invention |
| SA-2 | −28 | 5 | −5.1 | invention |
| SA-3 | −11 | 107 | 0.40 | invention |
| SA-4 | 3 | 170 | 0.52 | invention |
| SA-5 | 5 | 220 | 0.52 | invention |
| SA-6 | −30 | 220 | 0.36 | invention |
| SA-7 | −30 | 230 | 0.37 | invention |
| SA-8 | −40 | 180 | 0.28 | invention |
| SA-9 | −10 | 210 | 0.45 | invention |
| SA-10 | −10 | 180 | 0.44 | invention |
| SA-11 | 30 | 180 | 0.67 | invention |
| SA-12 | −5 | 250 | 0.48 | invention |
| SA-13 | 10 | 230 | 0.54 | invention |
| SA-14 | −10 | 230 | 0.46 | invention |
| SA-15 | −10 | 250 | 0.46 | invention |
| SA-16 | −5 | 280 | 0.48 | invention |
| SA-17 | 5 | 320 | 0.52 | invention |
| SA-18 | −21 | 280 | 0.43 | invention |
| SA-19 | −18 | 320 | 0.44 | invention |
| SA-20 | −17 | 380 | 0.46 | invention |
| SA-21 | −30 | 310 | 0.40 | invention |
| SA-22 | −40 | 380 | 0.39 | invention |
| SB-1 | 320 | 84 | 4.31 | Comparative Example |
| SB-2 | 192 | 35 | 5.99 | Comparative Example |
| SB-3 | −277 | 211 | −0.81 | Comparative Example |

*1All of the stretched films of Examples of the invention had an in-plane slow axis perpendicular to the stretching direction thereof; and both of Comparative Example Films SB-1 and SB-2 had an in-plane slow axis parallel to the stretching direction thereof, and Comparative Example Film SB-3 had an in-plane slow axis perpendicular to the stretching direction thereof.

From the results shown in the above table, it is understandable that the cellulose acylate films (SA-1 to 22) of Examples of the invention have a large absolute value of Re, a small absolute value of Rth and Nz value of 0.5 around. On the other hand, cellulose acylate having Substitution A, of which, however, the value “DSA2+DSA3−DSA6” and/or “DSA2+DSA3+DSA6” falls without the scope of the invention, or that is, the value does not satisfy the above relational expression (I) and/or (II), was used to produce the films of Comparative Examples (SB-1 to SB-3), and these comparative films had a large absolute value of Rth and Nz value significantly different from 0.5.

### 2.-2 Example 2

### Production of IPS-Mode Liquid-Crystal Display Device

### 2.-2-1 Preparation of Polarizing Plate

### 1) Saponification of Film

Each of Cellulose acylate films SA-7, SA-12 to 18, SA-20 and SB-1 to 3, which were produced according to the above mentioned methods, FUJITAC TF80UL (manufactured by FUJIFILM, referred to as “TAC A” hereiafter) and FUJITAC T40UZ (manufactured by FUJIFILM; referred to as “TAC B” hereinafter) was immersed in 1.5 mol/L-aqueous sodium hydroxide, saponifying liquid, of which temperature was controlled at 55° C., for two minutes, washed with water, immersed in 0.05 mol/L—sulfuric acid aqueous solution for 30 seconds, and immersed in a water-washing bath. Then, after water was drained off therefrom with an air-knife three times, each film was passed into a drying zone at 70° C. and left there for 15 seconds. In this way, each film was subjected to a saponification.

### 2) Preparation of Polarizing Film

A polarizing film, having a thickness of 20 μm, was prepared in the same manner as the method of Example 1 described in JPA No. 2001-141926. Specifically, a film was stretched along the long direction with two sets of nip rolls of which rim speed was different from each other.

### 3) Sticking

On the surfaces of the prepared polarizing film, Film A and Film B, selected from the above saponified cellulose acylate films and combined in the manner as shown in the following table, were stuck respectively using an adhesive of 3% aqueous solution of PVA (“PVA-117H” manufactured by Kuraray Co., Ltd.), so that the saponified surfaces contacted the surfaces of the polarizing film, the absorption axis of the polarizing film was perpendicular to the slow axis of Film A or B. In this way, Polarizing plates PSA-7, PSA-12 to 18, PSa-20 and PSB-1 to 3 were prepared.

Polarizing plates PSA-4 to 6, PSA-8 to 10 and PSB-4 to 6 were prepared in the same manner as the above, except that sticking was carried out so that the absorption axis of the polarizing film was parallel to the long axis of Film A or B. And, on the surface of TAC B, Film C, selected from Films SA-4 to 6, SA-8 to 10 and SB-1 to 3 and combined in the manner as shown in the following table, was stuck using an adhesive, so that the absorption axis of the polarizing film was perpendicular to the slow axis of Film C.

| Polarizing | | | |
|---|---|---|---|
| plate No. | Film A | Film B | Film C |
| PSA-4 | TAC A | TAC B | SA-4 |
| PSA-5 | TAC A | TAC B | SA-5 |
| PSA-6 | TAC A | TAC B | SA-6 |
| PSA-7 | TAC A | SA-7 | — |
| PSA-8 | TAC A | TAC B | SA-8 |
| PSA-9 | TAC A | TAC B | SA-9 |
| PSA-10 | TAC A | TAC B | SA-10 |
| PSA-12 | TAC A | SA-12 | — |
| PSA-13 | TAC A | SA-13 | — |
| PSA-14 | TAC A | SA-14 | — |
| PSA-15 | TAC A | SA-15 | — |
| PSA-16 | TAC A | SA-16 | — |
| PSA-17 | TAC A | SA-17 | — |
| PSA-18 | TAC A | SA-18 | — |
| PSA-20 | TAC A | SA-20 | — |
| PSB-1 | TAC A | SB-1 | — |
| PSB-2 | TAC A | SB-2 | — |
| PSB-3 | TAC A | SB-3 | — |
| PSB-4 | TAC A | TAC B | SB-1 |
| PSB-5 | TAC A | TAC B | SB-2 |
| PSB-6 | TAC A | TAC B | SB-3 |

2.-2-2 Production and Evaluation of IPS mode Liquid Crystal Display Device

The displaying-side polarizing plate was removed from an IPS mode liquid crystal display device (37-inch Hi-Vision type liquid crystal TV monitor “37Z2000” manufactured by TOSHIBA); and each of Polarizing plates PSA-4 to 10, PSA-12 to 18 and PSA-20 was set in the place of the displaying-side polarizing plate, so that Film B or Film C was close to the liquid crystal cell. In this way, IPS mode—liquid crystal display devices were produced. Each of liquid crystal display devices was evaluated in terms of displaying quality, and it was confirmed that sufficient optical compensation was achieved in all of the liquid crystal display devices, and that all of the liquid crystal display devices showed a good displaying quality.

IPS-mode liquid crystal display devices employing polarizing plates PSB-1 to 6 were produced in the same manner as the above, and it was confirmed that sufficient optical compensation was not achieved in each of the liquid crystal display devices, and that significant light leakage was observed in the oblique directions in each of the liquid crystal display devices.

What is claimed is:

1. A cellulose acylate film formed of a composition comprising at least one cellulose acylate having an aromatic group-containing acyl group (Substituent A), in which a substitution degree with Substituent A satisfies following relational expressions (I) and (II):
−0.25≦DSA2+DSA3−DSA6≦0.20, (I)
0.35≦DSA2+DSA3+DSA6, (II)
wherein DSA2, DSA3 and DSA6 each indicate a substitution degree with Substituent A at the 2-, 3- and 6-positions of the cellulose acylate.

2. The cellulose acylate film of claim 1, wherein the cellulose acylate satisfies following relational expression (III):
2.5≦DS≦3.0 (III)
wherein DS indicates a total substitution degree of the cellulose acylate.

3. The cellulose acylate film of claim 1, wherein the cellulose acylate further has an aliphatic acyl group (Substituent B).

4. The cellulose acylate film of claim 3, wherein the substitution degree, DSB, with Substituent B satisfies following relational expression (IV):
1.70≦DSB≦2.89. (IV)

5. The cellulose acylate film of claim 3, wherein Substituent B is a C₂₋₄ aliphatic acyl group.

6. The cellulose acylate film of claim 5, wherein Substituent B is an acetyl group.

7. The cellulose acylate film of claim 1, wherein Substituent A is selected from the group consisting of a benzoyl group, a phenyl benzoyl group, a 4-heptyl benzoyl group, a 2,4,5-trimethoxy benzoyl group and a 3,4,5-trimethoxy benzoyl group.

8. The cellulose acylate film of claim 1, wherein Substituent A is a benzoyl group, and the substitution degree with Substituent A satisfies following relational expression:
−0.2≦DSA2+DSA3−DSA6≦0.20.

9. The cellulose acylate film of claim 1, which is a stretched film.

10. The cellulose acylate film of claim 1, which is a retardation film.

11. An optical compensation film consisting of or comprising a cellulose acylate film as set forth in claim 1.

12. An antireflection film comprising a cellulose acylate film as set forth in claim 1, and an antireflection layer.

13. A polarizing plate comprising a polarizing film and a cellulose acylate film as set forth in claim 1.
